(19) United States
(12) Patent Application Publication
(10) Pub. No.: US 2026/0213831 A1
(43) Pub. Date: Jul. 23, 2026

(54) SYSTEMS AND METHODS FOR EXPOSING S&F EVENT INFORMATION FROM CN DURING TRANSITION BETWEEN TN AND NTN

(71) Applicant: Samsung Electronics Co., Ltd., Suwon-si (KR)

(72) Inventors: Lalith KUMAR, Bangalore (IN); Utsav SINHA, Bangalore (IN); Varini GUPTA, Bangalore (IN); Narendranath Durga TANGUDU, Bangalore (IN); Anurag MANDILWAR, Bangalore (IN); Vishal YADAV, Bangalore (IN)

(21) Appl. No.: 19/563,592

(22) Filed: Mar. 11, 2026

Related U.S. Application Data
(63) Continuation of application No. PCT/KR2025/015872, filed on Oct. 2, 2025.

(30) Foreign Application Priority Data
Oct. 4, 2024 (IN) 202441075141
Sep. 18, 2025 (IN) 2024 41075141

(51) Int. Cl. H04B 7/185

(52) U.S. Cl. CPC H04B 7/18513

(57) ABSTRACT

A method performed by a mobility management entity (MME) are provided. The method comprises detecting that a monitoring event that a user equipment (UE) is moving from being registered in a store and forward (S&F) mode to not being registered in the S&F mode, and in response to detecting the monitoring event, transmitting, to a service capability server/application server (SCS/AS), a message indicating that the UE is moving from being registered in the S&F mode to not being registered in the S&F mode.

### CROSS REFERENCE TO RELATED APPLICATION

This application is a continuation application, claiming priority under 35 U.S.C. § 365(c), of an International application No. PCT/KR2025/015872, filed on Oct. 2, 2025, which is based on and claims the benefit of an Indian Provisional patent application number 202441075141, filed on Oct. 4, 2024, in the Indian Intellectual Property Office, and of an Indian Complete patent application number 202441075141, filed on Sep. 18, 2025, in the Indian Intellectual Property Office, the disclosure of each of which is incorporated by reference herein its entirety.

### TECHNICAL FIELD

The disclosure relates to the field of satellite and wireless communication networks. More particularly, the disclosure relates to systems and methods for exposing Store and Forward (S&F) events information from a Fifth Generation (5G) core network.

### BACKGROUND

In existing terrestrial networks, all the Core Network Entities or Network functions are connected to each other. Due to this connected nature, all procedures between the User Equipment (UE) and the Network and between different network functions (NFs) or entities can be conducted seamlessly without any significant delay.

In Store and Forward (S&F) operation, a link between the UE and the Satellite (Service Link) and between the Satellite and the Ground Station (Feeder Link (FL)) are not connected at the same point of time.

FIG. 1 depicts the various types of links in a S&F operation according to the related art. However, providing the service to the UE can be challenging because not all the core network nodes are connected at the same time.

Currently, when data is attempted to be delivered to the UE, the data will be delivered instantaneously. But in case of S&F operations, the Service Link and the FL may not be available at the same time. On the service link becoming available, the Mobility Management Entity (MME) forwards the data to onboard the satellite, and on the satellite reaching the UE area, the satellite forwards the data to the UE. The Application Function (AF) assumes that there is no FL available, and waits for the FL to arrive without sending the data to the UE. But if the UE is in a non S&F cell where the FL is always available, and the AF is not in sync with which cell the UE is currently camped into, the UE will miss the mobile terminated data. This may result in taking hours to deliver data to the UE.

For example, the AF sends data to the core network at 5 o'clock, and the feeder link is established between the core network and the satellite at 7 o'clock. Thus, at 7 o'clock, data is uploaded on the satellite. Further, the satellite takes 3 hours to travel near the UE; i.e., the data is delivered to the UE at around 10 o'clock. Thus, it may take up to 5 hours in this example.

Additionally, in a traditional network, consider that the AF sends packet(s) to the UE, wherein the AF expects an acknowledgement in 10 seconds. Typically, the AF will get the response in 1 or 2 seconds. But, if the network is in S&F mode of operation using satellite access, it may take multiple hours to deliver data to the UE. The acknowledgement timer at the AF will expire, and the AF will end up retrying to send the same data. Thus, current solutions define a mechanism in which the Core Network (CN) can inform the AF as to how much delay that the AF can expect to deliver data to the UE, thus the AF can plan accordingly.

Consider a scenario, wherein an Application Function (AF) assumes that FL is not available; the AF therefore waits for a FL to arrive and does not send the data to the UE. However, if the UE is in a non S&F cell (where FL is always available), and the AF is not in sync with which cell the UE is currently camped into, the UE will miss the mobile terminated data.

FIG. 2A depicts a “normal/default Satellite operation” mode, according to the related art.

Referring to FIG. 2A, in a “normal/default Satellite operation” mode, signalling and data traffic exchange between a UE with satellite access and the remote ground network requires the service and feeder links to be active simultaneously. This enables a continuous end-to-end connectivity path between the UE, the satellite and the ground network, when the UE interacts over the service link with the satellite.

FIG. 2B depicts a S&F satellite operation mode, according to the related art.

Referring to FIG. 2B, in the “S&F Satellite operation” mode, the end-to-end exchange of signalling/data traffic is now handled as a combination of two steps, which are not concurrent in time (steps A and B in FIG. 2B). In step A, signalling/data exchange between the UE and the satellite takes place, without the satellite being simultaneously connected to the ground network (i.e. the satellite is able to operate the service link without an active feeder link connection). In step B, connectivity between the satellite and the ground network is established so that communication between the satellite and the ground network can take place. So, the satellite moves from being connected to the UE in step A to being connected to the ground network in step B.

In an example scenario, if the UE moves from a S&F cell to a non S&F cell, this change event is not monitored and informed to the AF. Thus, the AF will continue to assume data delivery time may take up to 10 hours and schedule data delivery accordingly. However, the UE may be on a non S&F cell and data delivery may just take a few seconds. Thus, there will be an impact on the mobile terminated data of the UE.

Further, it is not clear as to how the MME determines the change in the S&F cell to non S&F cell for the UE.

Further, if the UE silently moves from a S&F cell to a non S&F cell, it is not clear as to how the MME determines that the UE silently has moved from a S&F cell to a non S&F cell.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for managing transition of a User Equipment (UE) from a Store & Forward (S&F) cell to a non S&F cell, which involves detecting by a Mobility Management Entity (MME) that the UE has moved from the S&F cell to the non S&F cell, and indicating to the AF the UE is moving from a S&F mode to a not registered in S&F cell, wherein the AF schedules the data to the UE based on information received from the MME.

Another aspect of the disclosure is to provide the MME detecting that the UE has moved from the S&F cell to the non S&F cell in response to at least one of the following triggers, receiving a NAS message from the UE e.g. Tracking Area Update (TAU) message from the UE from the non S&F cell, and receiving an indication from the Home Subscriber Server (HSS) to delete the UE context.

Another aspect of the disclosure is to provide the UE is configured with a Tracking Area Identity (TAI) list, wherein the TAI list comprises only S&F cells or only the non S&F cells, wherein the UE will trigger the TAU procedure in response to moving out of S&F cells and selecting a non S&F cell, or vice versa.

Another aspect of the disclosure is to provide the MME communicating an estimated S&F DL Delivery Time and a feeder link (FL) availability period to the AF, on determining that the UE has moved from the S&F cell to the non S&F cell, or vice versa.

Additional aspects will be set forth in part in the description which follows and, in part, will be apparent from the description, or may be learned by practice of the presented embodiments.

In accordance with an aspect of the disclosure, a method for managing transition of a UE from an S&F cell to a non-S&F cell or vice versa is provided. The method includes moving, by the UE, from the S&F cell to the non-S&F cell or vice versa, and triggering, by the UE, a tracking area update (TAU) procedure.

In accordance with another aspect of the disclosure, a method for managing transition of a UE from an S&F cell to a non-S&F cell or vice versa is provided. The method includes detecting, by a mobility management entity (MME), that the UE has moved from the S&F cell to the non-S&F cell or vice versa, and notifying, by the MME, an application function (AF) that the UE has moved from the S&F cell to the non-S&F cell or vice versa.

In accordance with another aspect of the disclosure, a UE is provided. The UE includes a transceiver, memory, comprising one or more storage media, storing instructions, and one or more processors communicatively coupled to the transceiver and the memory, wherein the instructions, when executed by the one or more processors individually or collectively, cause the UE to trigger a tracking area update (TAU) procedure, on the UE moving from a store & forward cell (S&F) cell to a non-S&F cell or vice versa.

In accordance with another aspect of the disclosure, an MME is provided. The MME includes a transceiver, memory, comprising one or more storage media, storing instructions, and one or more processors communicatively coupled to the transceiver and the memory, wherein the instructions, when executed by the one or more processors individually or collectively, cause the MME to detect that a user equipment (UE) has moved from the S&F cell to the non-S&F cell or vice versa, and notify an application function (AF) that the UE has moved from the S&F cell to the non-S&F cell or vice versa.

In accordance with another aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include moving, by the UE, from a store & forward cell (S&F) cell to the non-S&F cell or vice versa, and triggering, by the UE, a tracking area update (TAU) procedure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 depicts an example integration of satellite components in the 5G architecture, according to the related art;

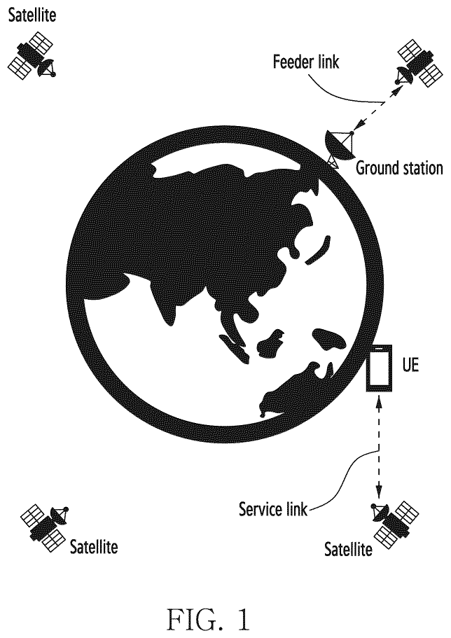

FIG. 2A depicts a “normal/default Satellite operation” mode, according to the related art;

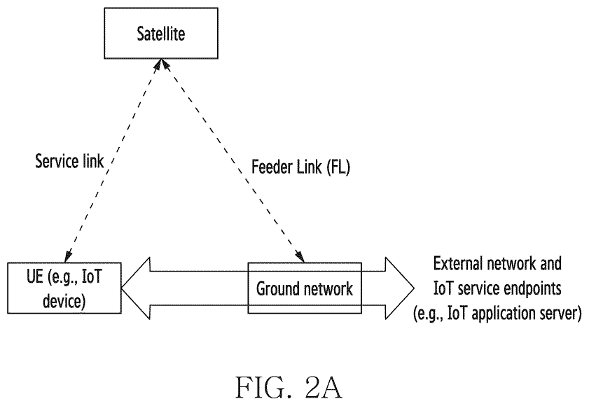

FIG. 2B depicts a S&F satellite operation mode, according to the related art;

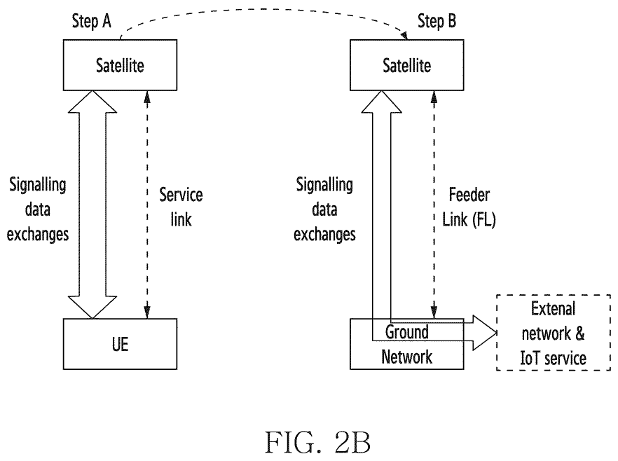

FIG. 3 is a sequence diagram illustrating exposure of the S&F event information to the AF, according to an embodiment of the disclosure;

FIG. 4 depicts a network, according to an embodiment of the disclosure;

FIG. 5 depicts the process of handling transitioning between S&F mode to not in S&F mode, according to an embodiment of the disclosure;

FIG. 6 is a block diagram of a terminal or user equipment (UE), according to an embodiment of the disclosure;

FIG. 7 is a flowchart depicting the process of managing the transition of the UE from a S&F cell to the non-S&F cell or vice versa, according to an embodiment of the disclosure;

FIG. 8 depicts the MME, according to an embodiment of the disclosure; and

FIG. 9 is a flowchart depicting the process of the MME managing the transition of the UE from a S&F cell to the non-S&F cell or vice versa, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. The blocks of the embodiments may be physically combined into more complex blocks without departing from the scope of the disclosure.

It should be noted that elements in the drawings are illustrated for the purposes of this description and ease of understanding and may not have necessarily been drawn to scale. In an example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

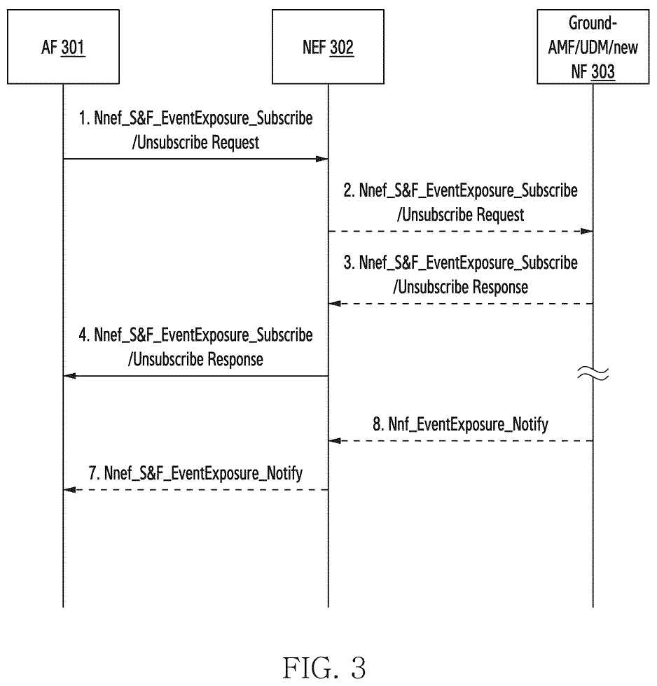

The embodiments achieve methods and systems for managing transition of a User Equipment (UE) from a Store & Forward (S&F) cell to a non S&F cell and vice versa, which involves detecting by a Mobility Management Entity (MME) that the UE has moved from the S&F cell to the non S&F cell, and indicating to the AF the UE is moving from a S&F mode to a not registered in S&F cell, wherein the AF schedules the data to the UE based on information received from the MME. Referring now to the drawings, and more particularly to FIGS. 3 through 9, where similar reference characters denote corresponding features consistently throughout the figures, there are shown embodiments.

Embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the embodiments disclosed herein and more clearly transfer the embodiments disclosed herein.

In the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. In describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

It will be understood that each block of the flowchart illustrations, and combinations of blocks in the flowchart illustrations, may be performed based on computer program instructions. These computer program instructions may be loaded individually or collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also, for example, be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments, a “~unit/module” may refer to a software element or a hardware element, such as a field programmable gate array (FPGA) or an application specific integrated circuit (ASIC), which performs a predetermined function. However, the term including the word “~unit/module” does not always have a meaning limited to software or hardware. The “~unit/module” may be constructed either to be stored in an addressable storage medium or to execute one or more processors. Therefore, the “~unit/module” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “~unit/module” may be either combined into a smaller number of components and a “~unit/module,” or divided into additional components and a “~unit/module.” Moreover, the components and “~units/module” may be implemented to reproduce one or more central processing units (CPUs) within a device or a security multimedia card. Further, in the embodiments, the “~unit/module” may include one or more processors.

The entirety of the one or more computer programs may be stored in a single memory device, or the one or more computer programs may be divided with different portions stored in different multiple memory devices.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, microprocessors, microcontrollers, digital signal processors, FPGA, ASIC, a microprocessor unit (MPU), a system on chip (SoC), an IC, or the like.

The one processor or the combination of processors executes instructions that can be stored in memory, such as the operating system, in order to control the overall operation of the device. Also, the one processor or the combination of processors is also capable of executing other processes and programs resident in the memory, such as processes for the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure. Additionally, or alternatively, such software may be a computer program [product] comprising instructions which, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the disclosure may provide a program comprising code for implementing apparatus or a method as claimed in any one of the claims of this specification and a non-transitory machine-readable storage storing such a program.

Hereinafter, the determination of priority between A and B in the disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the disclosure may be understood as “A and/or B,” which may include A, or B, or both A and B.

In addition, “at least one of A, B, and C” as described in the disclosure may be understood to include A, or B, or C, or any combination of A, B, and C.

In addition, “at least one of A, B, or C” as described in the disclosure may be understood to include A, or B, or C, or any combination of A, B, and C.

Furthermore, “A/B” as described in the disclosure may be understood as “A and/or B,” which may include A, or B, or both A and B.

Furthermore, “A, B” as described in the disclosure may be understood as “A and/or B,” which may include A, or B, or both A and B.

Furthermore, “A and B” as described in the disclosure may be understood as “A and/or B,” which may include A, or B, or both A and B.

Furthermore, “if condition A and condition B are satisfied,” as described in the disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, elements or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ~”, “second ~”, etc., as described in the disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ~” and “second ~” are described in the disclosure, it may be understood that element(s) referred to by “first ~” and “second ~” may be the same or different. For example, in case of element(s) being information, first information and second information may both be the same information, and, in some cases, are separate and different information.

The terms “if ~” and “in case that ~” as used in the disclosure or claims may be interpreted to include the meanings of “when (or upon) ~,” “in response to ~,” “based on ~,” or “according to ~,” and may be used interchangeably with these expressions. In addition, expressions other than those exemplified herein may also be used, as long as they have substantially the same meaning and do not impair the technical features of the disclosure. If a method step (e.g., transmit a signal) is performed according to the disclosure of the application in connection with one of the above terms (such as “in case that ~” or the like), it may be interpreted to include the meanings (disclosure) of a prior determination that a feature has a specific state “~” (e.g., a bit length is above X), and then perform the method step in response to said determination.

In addition, the term “not perform” as used in the disclosure or claims may, in context, be understood to mean that the corresponding step is omitted or skipped. Such a term may be replaced with other terms having the same or substantially equivalent meaning.

In addition, “transmitting a message including A and B” as described in the disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the disclosure described below, terms or components included in the disclosure may be expressed in singular or plural form depending on the specific embodiments presented. However, such singular or plural expressions are selected appropriately for convenience of description, and the disclosure is not limited to a singular or plural number of components. A component expressed in the plural form may be implemented as a single component, and a component expressed in the singular form may be implemented as multiple components.

The drawings or flowcharts described below illustrate example methods that may be implemented according to the principles of the disclosure, and various modifications may be made to the methods illustrated in the flowcharts of the disclosure. For example, although illustrated as a series of steps, various steps in each drawing or flowchart may overlap, occur in parallel, occur in a different order, or be repeated. In other examples, any step may be omitted or replaced with another step.

The process of the flowchart may be performed by a device. One or more of the steps of the flowchart can be implemented by one or more processors/computer programs executing instructions to perform the noted functions.

The methods and apparatuses proposed in the embodiments of the disclosure may be disclosed in connection with drawings disclosing flowcharts to illustrate example methods that may be implemented according to the principles of the disclosure. Such flowcharts may contain different branches and/or sub-branches. It is understood that the principles of the disclosure do not only contain the combination of all branches/sub-branches disclosed in the embodiment, but the disclosure also contains at least one isolated branch/isolated sub-branch, in particular to a single branch/single sub-branch.

The methods and apparatuses proposed in the embodiments of the disclosure are not limited to each embodiment individually, but may also be applied in combination of all or some of the embodiments proposed in the disclosure. Therefore, the embodiments of the disclosure may be modified and applied without significantly departing from the scope of the disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the disclosure is not limited to the terms described below, and other terms having equivalent technical meanings may also be used. Such terms may also be interchangeable with terms defined in any 3rd generation partnership project (3GPP) technical specifications (TS) or similar technical specifications, e.g., from ETSI, where appropriate.

Hereinafter, a base station (BS) is an entity that allocates resources to terminals, and may be at least one of a gNodeB (gNB), an eNodeB (eNB), a NodeB (NB), a wireless access unit, a BS controller, or a node on a network.

The operational principle of the disclosure will be described in detail with reference to the accompanying drawings.

Embodiments herein disclose systems and methods for exposing S&F events information from a 5G core network. A Network Function (NF) (for example, Access and Mobility Management Function (AMF), Unified Data Management (UDM), a new NF, and so on) exposes Store & Forward (S&F) event information in a Nnf_EventExposure_Notify service. A Network Exposure Function (NEF) notifies the S&F event information towards the AF in a Nnef_S&F EventExposure_Notify service. An AF subscribes to the S&F event information using a Nnef_S&F_EventExposure_Subscribe service. The NF subscribes to another NF to receive the S&F event information for a given User Equipment (UE) or list of UEs using Nnef_S&F_EventExposure_Subscribe. In case of a Long Term Evolution (LTE) network, embodiments herein expose “Registration in S&F Mode”, “Feeder Link Available” and “S&F Delay Time” S&F event information by the AMF/UDM/new NF in case of 5G and Mobility Management Entity (MME) or Home Subscriber Server (HSS).

In an embodiment, S&F satellite operation assumes that UE-satellite-ground network connectivity can be intermittent. The S&F Satellite operation is especially suited for the delivery of delay-tolerant/non-real-time satellite services (for example, Cellular Internet of Things/Machine-Type Communications (CIoT/MTC), Short Message Service (SMS), and so on). To support the S&F satellite operation for such services, embodiments herein disclose enhancements on the related UE and network procedures to support S&F Satellite operation, including, whether to inform the UE when the S&F Satellite operation is applied or not. Also, during S&F Satellite operation, the service delivery/consumption can be enhanced by the AF/UE with respect to aspects such as, but not limited to, Quality of Service (QoS), data size, scheduling, and so on, using the S&F event received by the AF.

When the UE registers to the network in S&F mode and is available to send/receive data on specific occasions only (e.g., when satellites flyover and later connect to a ground station), it may be desirable to expose information such as below to an application function. This will help an AF adjust its logic as described below:
UE registered in S&F Mode: If the UE is registered in S&F mode, the AF may want to adjust the frequency, size of data, expected QoS etc. The UE is registered in S&F mode implies that the UE is registered in NG-RAN satellite access, but there is no simultaneous feeder link and service link.
When will the Feeder Link (FL) be available: This will help the AF to schedule delivery as and when the FL becomes available. For example, it may indicate at this time (for example, 11 minutes) or after this duration (for example, 30 minutes) or it can indicate the frequency at which the FL will be available.
Expected delivery time: The delivery of data will require the following events:
Availability of FL to deliver data to EPC/5GC and further to the Satellite.
Availability of Service-Link to deliver data to the UE and receive acknowledgement.
Availability of Feeder-Link to deliver acknowledgement to the EPC/5GC, and further to the AF

The expected delivery time of any data packet of a message (for example, a signalling message) sent from the AF to the UE, can be provided to the AF, so that retry timers and retry mechanisms can be scheduled/readjusted accordingly. Accordingly, embodiments herein define new monitoring events and expose the defined monitoring events via NEF/AF.

In an embodiment, the AMF, UDM, or a new NF can expose the events as listed in Table 1. In an embodiment herein, for an LTE network, the MME or HSS can expose the events as listed in Table 1.

TABLE 1

| | | Which NF detects |
|---|---|---|
| Event | Detection criteria | the event |
| Registration | Detected when the UE registers in | Ground- |
| in S&F Mode | S&F Mode. The event report may | AMF/MME/ |
| | include an indication of S&F Mode | UDM/HSS |
| | and optionally satellite ephemeris | |
| | data etc. SO that AF can determine | |
| | when the feeder link will be available | |
| | and the service link will be available | |
| | to AF | |
| Feeder Link | Network detects that Feeder Link is | Ground- |
| Available | available for AF to send data to a UE. | AMF/MME |
| | The event report may include | |
| | duration for which the feeder link is | |
| | available. | |
| | Alternatively, the AF may query the | |
| | network to determine when the | |
| | feeder-link will be available next or | |
| | in which frequency. | |
| S&F Delay | The expected delay duration to | Ground- |
| Time | deliver the data to the UE. This | AMF/MME |
| | information may be informed to the | |
| | AF based on query, or when data sent | |
| | by AF is cached into EPC/5GC, or | |
| | along with the “Feeder Link | |
| | Available” event. | |
| Service link | Network informs the AF when the | |
| availability | service link will be available to the | |
| | UE, this implies to the AF when the | |
| | data will be delivered to the UE or | |
| | when will the MO data from the UE | |
| | will be sent | |

Service link Network informs the AF when the availability service link will be available to the UE, this implies to the AF when the data will be delivered to the UE or when will the MO data from the UE will be sent

FIG. 3 is a sequence diagram illustrating exposure of the S&F event information to the AF according to an embodiment of the disclosure.

At step 1, the AF 301 sends a Nnef_S&F_EventExposure_Subscribe Request to a NEF 302, requesting notifications for a UE or group of UEs related to S&F Satellite Operation for at least one of the following elements:
a) Registration in S&F Mode;
b) Feeder Link Available;
c) S&F Delay Time; and
d) The time or duration, which can be in at least one of the following forms:
The time to deliver the data to the UE.
Round-trip time, i.e., total time to deliver data to the UE and receive an ack. This can be in the range between best effort to worst effort (for example, 2 to 10 hours). In an example scenario, if the first attempt to deliver the data has failed and if this has to go through a second pass, then it may take a longer time.
Time at which any mobile orientated (MO) data/message can be initiated from the UE

The above elements (a)-(d) are referred to herein as S&F event information. The AF can register for one or more S&F event information in any combination of these elements.

Event Reporting Information indicates the type of reporting requested (for example, one-time reporting, periodic reporting or event based reporting, for monitoring events). If the reporting event subscription is authorized by the NEF 302, the NEF 302 records the association of the event trigger and the requester identity. The subscription may also include the maximum number of reports and/or maximum duration of reporting IE.

At step 2, the NEF 302 sends a request to subscribe to “S&F event” in Nnf_EventExposure_Subscribe request to one of a ground-AMF/UDM/new NF 303. The NEF 302 provides the associated notification endpoint of the Event Receiving NF. If the NEF 302 itself is not the Event Receiving NF, the NEF shall additionally provide the notification endpoint of itself besides the notification endpoint of the Event Receiving NF. The event reporting information defines the type of reporting requested. If the requested subscription is authorized by the NEF 302, the NEF 302 records the association of the event trigger and the requester identity.

In an embodiment, any NF (for example, SMF, UDM, PCF, and so on) can subscribe to the S&F event from another NF using Nnf_EventExposure_Subscribe request.

At step 3, the ground-AMF/UDM/new NF 303 acknowledges the execution of Nnf_EventExposure_Subscribe request. At step 4 (which is conditional, depending on an occurrence of the event), the AF 301 detects that the monitored event (i.e., S&F event) has occurred and sends the event report by means of Nnef_S&F_EventExposure_Notify message, to the notification endpoint of the Event Receiving NF (i.e., NEF). At step 5, the NEF 302 sends a Nnef_S&F_EventExposure_Notify with S&F event information to the AF 301.

In an embodiment herein, the NEF 302 can provide the S&F event information to the AF 301 via a Request-Response method.

In an embodiment herein, the S&F event information can be made available to the UE.

In an embodiment, in an LTE network, the MME or HSS can expose the following: “Registration in S&F Mode”, “Feeder Link Available” and “S&F Delay Time”.

In an embodiment, the FL availability information can be made available from an Operations, Administration and Maintenance (OAM) entity.

Embodiments herein disclose methods and systems for managing transition of a User Equipment (UE) from a Store & Forward (S&F) cell to a non S&F cell, which involves detecting by a Mobility Management Entity (MME) that the UE has moved from the S&F cell to the non S&F cell, and indicating to the AF the UE is moving from a S&F mode to a not registered in S&F cell, wherein the AF schedules the data to the UE based on information received from the MME. Embodiments herein disclose the MME detecting that the UE has moved from the S&F cell to the non S&F cell in response to at least one of the following triggers; receiving a NAS message example Tracking Area Update (TAU) or Attach message from the UE from the non S&F cell; and receiving an indication from the Home Subscriber Server (HSS) to delete the UE context. Embodiments disclose the UE is configured with a Tracking Area Identity (TAI) list, wherein the TAI list comprises only S&F cells or only non S&F cells, wherein the UE will trigger the NAS procedure example TAU procedure in response to moving out of S&F cells and selecting a non S&F cell, or vice versa. Embodiments herein disclose the MME communicating an estimated S&F DL Delivery Time and a feeder link (FL) availability period to the AF, on determining that the UE has moved from the S&F cell to the non S&F cell.

If feeder link availability period is not included in the signal to the AF from the MME, the Estimated S&F DL Delivery Time is the estimated/expected time required to deliver the data to the UE from the time data has been received in the network. If the feeder link availability period, for example, is included in the signal to the AF from the MME, the Estimated S&F DL Delivery Time is the estimated/expected time required to deliver the data to the UE after the feeder link has been established.

The terms ‘UE in S&F mode’ to a ‘UE not in S&F mode’ implies that the UE is moving from a network operating in S&F Mode to a network not operating in S&F Mode; i.e., the UE starts operation in S&F mode only if the UE is served by a network which includes a RAN node (for example, eNB or gNB, MME/AMF or any other core network) operating in S&F mode. The eNB/gNB broadcasts support of the S&F mode when operating in S&F mode.

The term ‘UE is registered in S&F mode’ implies that the UE is in S&F mode. The term ‘UE is not registered in S&F mode’ also implies that the UE is not in S&F mode.

The terms ‘registered’ and ‘attached’ implies that the UE is registered or attempting to register on the network and have the same meaning.

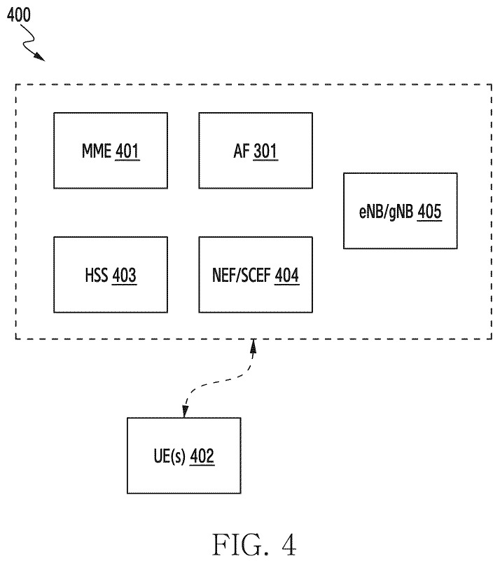

FIG. 4 depicts a network 400 according to an embodiment of the disclosure.

The network 400, as depicted, comprises an MME 401, at least one UE 402, at least one AF 301, a HSS 403, a NEF/SCEF 404, and an eNB/gNB 405. In an embodiment, the MME 401 can detect that the UE 402 is no longer registered in S&F mode. In an example scenario, the UE 402 is no longer registered in S&F mode, on the UE moving from an area where it was registered for S&F mode (also can be referred to as a network operating in S&F Mode) to an area where it is not registered in S&F mode (also can be referred to as a network not operating in S&F Mode). The MME 401 can detect that the UE 402 is no longer registered in S&F mode using at least one of the below mechanisms:
a) When the MME 401 receives an event from the HSS 403 that the UE context has to be deleted; for example, when the MME 401 receives a cancel location request from the HSS 403, which can be after the MME 401 sends the cancel location ack back.
b) When the MME 401 transfers the UE context to a target NF (another new MME or the AMF or any other mobility node); for example, when the MME 401 receives the context request and optionally, after the MME responds with the context response or when the context acknowledgement message is received by the MME 401.
c) When the MME 401 executes the detach/deregistration procedure (for example, due to a UE initiated detach procedure or a network initiated detach procedure or the MME 401 performing a local detach procedure).
d) When the MME 401 deletes/removes the UE context (for example, when a mobile reachability timer has expired or an implicit deregistration/detach timer has expired or due to at least one reason as specified in TS 24.501, TS 23.501 or TS 23.401, TS 24.301).
e) When the UE 402 performs a NAS procedure (e.g. TAU procedure or registration procedure) in a new MME or AMF, the MME 401 detects that the UE is not registered in S&F mode either over satellite access or over terrestrial/ground access. The UE is not on the cell/AMF/MME (in general, the network) that broadcasts support of S&F mode; i.e., the cell/AMF/MME do not provide S&F services; i.e., the UE 402 is on the cell which does not indicate the S&F support/S&F mode.

In an embodiment, the NEF/SCEF 404 can detect that the UE is not registered for S&F mode, if the NEF/SCEF 404 (Service Capability Exposure Function) can detect the change in the serving MME or the serving AMF; i.e., for example, the UE context is moved from a) MME-1 to MME-2 or AMF or b) from AMF-1 to AMF-2 or MME.

In an embodiment, the UDM/HSS or any other NF can detect that the UE 402 is not registered for S&F mode if an event is detected by the respective network function or core network element that the UE context is deleted in the current serving MME 401 or AF 301, or the UE context is moved to a new MME or new AMF.

When the MME 401 detects that the UE 402 is no longer (i.e. not) registered for S&F mode (for example, the UE 402 is moving from registered in S&F mode to not registered in S&F mode), the MME 401 will indicate the same (for example, no more (i.e., not) registered for S&F mode) to the AF 301 optionally via the NEF/SCEF 404; i.e., the MME 401 indicates to the NEF/SCEF 404 which in turn indicates to the AF 301 that the UE 402 is no longer registered for S&F mode. The MME 401 indicates/notifies the discussed information to the subscribed AF 301. For this, the SCS/AS (also called as AF herein) sets Monitoring Type to “Store and Forward Satellite operation information” prior to sending a Monitoring Request to the SCEF. The SCEF will subscribe to this monitoring event in the MME or in the HSS 403, and the HSS 403 in turn will subscribe for this event with MME. When the event occurs (i.e., the UE 402 is not registered in S&F mode), the MME 401 notifies the subscribed AF (via the SCEF directly or via the HSS and then SCEF) that the UE 402 is not registered in S&F mode (because the UE is deregistered or the UE 402 has moved into an area where S&F is not supported or is not required).

To detect whether the UE 402 is registered for S&F mode or not registered for S&F mode, the network allocates the TAI list (i.e., registration area only with the TAIs that support S&F mode or with the TAIs which does not support S&F mode). So that when the UE 402 moves from a TAI that supports S&F mode to a TAI that does not support S&F mode, the UE 402 triggers the TAU procedure or the registration procedure.

When the UE 402 moves from an area where S&F mode is supported to an area where the S&F mode is not supported, the UE 402 triggers the NAS procedure (for example, TAU procedure, the registration procedure, the service request procedure, and so on). Due to this TAU/registration/service request procedure, the MME/AMF/UDM/NEF or any other core network element or network function detects that the UE 402 is either in S&F mode or not in the S&F mode, and appropriately indicates this change in S&F registration status to the AF 301.

The term “registered in S&F mode” implies that the UE 402 has detected the support of S&F broadcasted from the network (for example, eNB or gNB), the UE 402 has triggered a NAS procedure (for example, a registration or a service request procedure (for example, attach procedure or TAU procedure)) on such a cell, and the UE 402 has successfully executed the registration procedure (for example, attach procedure or TAU procedure or registration procedure). Optionally, the UE 402 has indicated the support of S&F mode to network in at least one NAS message (for example, attach message, TAU message or registration request message).

The term “UE is registered in S&F mode” implies that the UE 402 is reachable only in S&F mode.

The term “UE is not registered in S&F mode” implies that the UE 402 is not reachable in S&F mode of operation, however the UE 402 may be reachable in non-S&F modes of operation. The term “not registered in S&F mode” implies that the UE 402 has detected that the support of S&F has not been broadcasted from the network (e.g., eNB or gNB), the UE 402 has triggered a registration procedure (for example, attach procedure or TAU procedure) on such a cell, and the UE 402 has successfully/not successfully executed the registration procedure (for example, attach procedure or TAU procedure or registration procedure) on such a cell (i.e., the network detects that the UE is in the area where S&F is not supported or the UE 402 does not need an S&F services). The network can, for example, also detect that the UE 402 is in the S&F mode when the UE 402 indicates S&F capability to the network and is not in the S&F mode, when the UE 402 does not indicate the S&F mode capability to the network. The UE 402 indicates S&F mode capability (and enter the S&F mode) only if the UE 402 determines that the current camped cell supports S&F operation/mode/service. Optionally, the UE 402 wants to receive the S&F services, if the UE 402 determines that the network does not support S&F mode/service (for example, the eNB/gNB/RAN node does not broadcast support of S&F mode or the UE 402 does not want to receive the S&F mode services), then the UE 402 shall not enter the S&F mode and does not indicate S&F mode/capability to the network node. Optionally, if the UE 402 does not want to receive S&F services, then the UE 402 shall bar the cell (i.e. does not select/reselect) which supports S&F services.

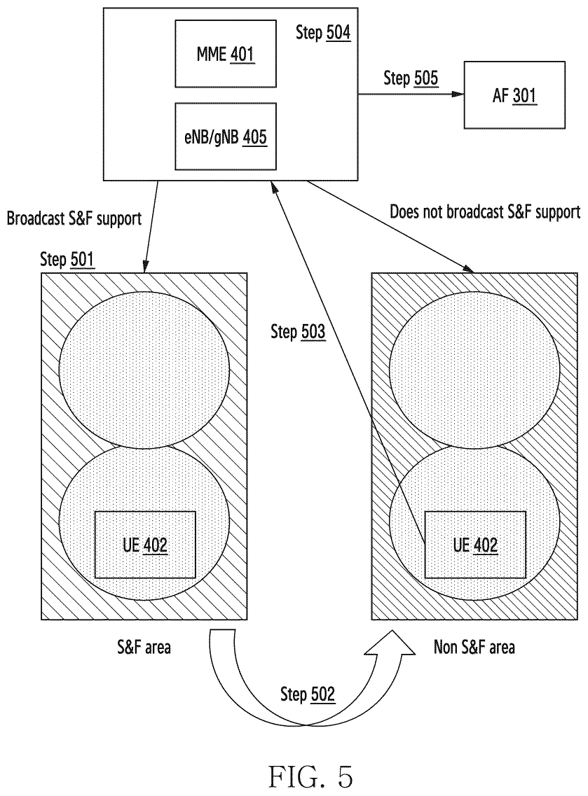

FIG. 5 depicts the process of handling transitioning between S&F mode to not in S&F mode according to an embodiment of the disclosure.

Consider that there are two areas, wherein a first area is a S&F area (wherein the network broadcasts support of S&F mode) and a second area is a non S&F support area (where the network does not broadcast the support of S&F mode). In step 501, the UE 402 is registered through the cell of S&F mode. In step 502, the UE 402 moves from the S&F area to the non S&F area. In step 503, the UE 402 triggers the NAS procedure (for example, the TAU procedure). In step 504, the MME 401 detects that UE 402 has moved from the S&F area to the non S&F area, wherein the UE 402 communicates with the MME 401 via the eNB/gNB 405. In step 505, the MME 401 indicates this change in the UE status from the S&F area to the non S&F area along with new values of expected delivery time and FL availability status to the AF 301.

Embodiments herein enable the MME 401 to detect that the UE 402 has moved to a non S&F cell. In an embodiment herein, the MME 401 can detect that UE 402 is no more registered in S&F mode, i.e., the MME 401 detects by at least one of the below mechanisms that UE is not registered in S&F mode (for example, when the UE moves from an area where it was registered for S&F mode to an area where it is registered normally; i.e., not in S&F mode):
When the MME 401 receives an event from the HSS that UE context has to be deleted for e.g. when MME 401 receives the Cancel location request from the HSS 403, which optionally be after the MME 401 sends back the cancel location ack.
When the MME 401 transfers the UE context to another target NF (for example, to another new MME or AMF or any other mobility node). In an example scenario, the MME 401 transfers the UE context to another target NF on the MME 401 receiving the context request and optionally after the MME 401 responds with the context response or when a context acknowledgement message is received by the MME 401.
When the MME 401 executes the detach/deregistration procedure, which can be for example, due to a UE initiated detach procedure or a network initiated detach procedure or the MME 401 performs a local detach procedure.
When the MME 401 deletes/removes the UE context, which can be for example, when a mobile reachability timer has expired or an implicit deregistration/detach timer has expired or due to at least one reason as specified in TS 24.501, TS 23.501 or TS 23.401, TS 24.301.
When the UE 402 performs a NAS procedure TAU procedure or a registration procedure in a new MME or AMF, the new MME or AMF detects that the UE 402 is not registered in S&F mode either over satellite access or over the terrestrial access; i.e., the UE 402 is not on the network (i.e., the cell/AMF/MME) (which implies that the UE 402 is not camped on the network) which broadcasts support of S&F mode (i.e., the network does not provide S&F services); i.e., the UE 402 is on the cell which does not indicate the S&F support/S&F mode.

When the MME 401 detects that the UE 402 is not registered for S&F mode (in an example scenario, which can be due to the UE 402 moving from registered in S&F mode to not registered in S&F mode), the MME 401 can indicate the same (for example, not registered for S&F mode) to the AF 301 directly or via the NEF/SCEF 404 (i.e., the MME 401 indicates to the NEF/SCEF 404, which in turn indicates to the AF 301 that the UE 402 is no longer registered for S&F mode). In an embodiment, the MME 401 indicates/notifies an Estimated S&F DL Delivery Time and/or the feeder link availability period or both information to the subscribed AF. For this, the AF 301 (which can be the SCS/AS) sets Monitoring Type to “S&F Satellite operation information” prior to sending a Monitoring Request to the SCEF. In an embodiment herein, the SCEF can subscribe to this monitoring event in the MME directly. In an embodiment herein, the SCEF can subscribe to this monitoring event in the HSS 403, and the HSS 403 in turn, will subscribe to this event with the MME 401. When the event occurs (i.e., the UE 402 is not registered in S&F mode), the MME 401 notifies the subscribed AF (via the SCEF or via the HSS and then the SCEF) that the UE 402 is not registered in S&F mode as the UE 402 is deregistered or the UE 402 has moved into an area where S&F is not supported or is not required.

To detect whether the UE 402 is registered for S&F mode or not registered for S&F mode, the network allocates the TAI list to the UE in registration/attach/TAU procedure. In an embodiment herein, the TAI list can comprise TAIs that support S&F mode. In an embodiment, the TAI list comprises TAIs which do not support S&F mode. So that when the UE 402 moves from a TAI which supports S&F mode to a TAI which does not support S&F mode, the UE 402 triggers the NAS procedure (for example, TAU procedure or the registration procedure or service request). When the UE 402 moves from an area where S&F mode is supported to an area where the S&F mode is not supported, the UE 402 triggers the TAU procedure or the registration procedure. Due to this NAS procedure e.g. TAU/registration procedure, the MME/AMF/UDM/NEF or any other core network element or network function detects that the UE 402 is either in S&F mode or not in the S&F mode and appropriately indicates this change in S&F registration status to the AF 301.

When the UE 402 moves from S&F cells to non S&F cells, the network can determine that the UE 402 has moved from S&F cells to non S&F cells. Embodiments herein disclose a new trigger for the NAS procedure (for example, TAU procedure). On the Network detecting that the UE 402 has moved from S&F cells to non S&F cells, the network indicates the same to the AF 301 along with additional S&F parameters. The AF 301 can be aware if the UE 402 has moved to a non S&F cell. The AF 301 can determine the correct time of delivery of data to the UE 402. The AF 301 can be in sync with the current UE status.

When the UE is in the S&F mode, consider that the FL link is available at 10:00, 12:00, and 14:00 only for 10 minutes each. Thus, to send any data, the AF 301 has to plan to send it between 10:00 and 10:10 or re-attempt it at 12:00 after ~2 hours. When the UE 402 is not in a S&F cell (i.e. in a normal cell), the FL is always available, and the AF 301 can send data to the UE 402 at any point in time. Thus, there is no delay in sending the data to the UE 402. Thus, it is important to keep the AF updated about the current UE registration mode, otherwise the AF 301 will unnecessarily delay in sending the data, as the AF 301 wrongly assumes that it may take a few hours (~2 hours) to send data to the UE 402.

In an embodiment, the UE 402 triggers the TAU procedure when moving from the S&F mode cell to the non S&F cell. The UE 402 can be configured with a TAI list (i.e. registration area) of only S&F cells, wherein the UE will trigger a TAU procedure, on the UE 402 moving out of the S&F cell and camping on the non S&F cell (which is not a S&F cell). The MME 401 can monitor the event (i.e., the change in the S&F registration status as the UE moves to the non S&F cell). The MME 401 can then indicate the estimated S&F DL Delivery Time and the feeder link availability period to the AF 301. The MME 401 can detect this event, on the UE 402 registering from a cell that does not support S&F.

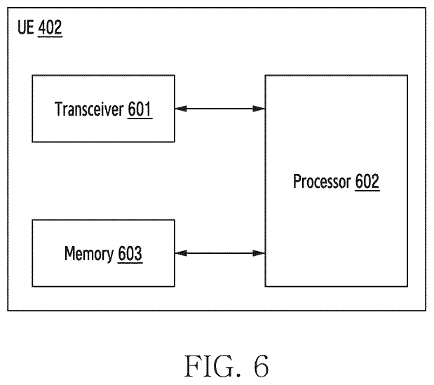

FIG. 6 is a block diagram of a terminal or user equipment (UE) 402 according to an embodiment of the disclosure.

The terminal is an electronic device capable of wireless communication and having various form factors, examples of the terminal may include a UE, a mobile station (MS), a cellular phone, a smartphone, a computer, a tablet, a wearable device, an Internet of Things (IoT) device, or any other device/system capable of performing wireless communication with a base station (BS) and/or another terminal through a wireless channel.

Referring to FIG. 6, the UE 402 may include at least one transceiver (hereinafter, referred to as simply “transceiver”) 601, at least one processor (hereinafter, referred to as simply “processor”) 602, and at least one memory (hereinafter, referred to as simply “memory”) 603. According to at least one or a combination of methods corresponding to the embodiments described in the disclosure, the transceiver 601, the processor 602, and the memory 603 of the UE 402 may operate. However, components of the UE 402 are not limited to the example components illustrated in FIG. 6. In another embodiment, the UE 402 may further include additional components in addition to the above-mentioned components, or some components may be omitted. Further, in some embodiments, any combination of the transceiver 601, the processor 602, or the memory 603 may be integrated in the form of one component.

In an embodiment, the transceiver 601 may be a communication circuit or communication circuitry that enables the UE 402 to perform wireless communication with a node or an entity of a network. For example, the transceiver 601 may enable the UE 402 to transmit or receive a signal to or from a BS through cellular communication, or to transmit or receive a signal to or from another UE through cellular communication. For example, the transceiver 601 may support at least one of various cellular communication technologies including 3rd generation (3G), 4th generation (4G), long term evolution (LTE), 5th generation (5G) NR, 6th generation (6G), and various cellular wireless communication technologies supported by the transceiver (601) may include all subsequent generations of evolved wireless communications.

The transceiver 601 may include various circuit structures used to transmit or receive signals to or from a BS through a wireless channel. The signals may include control information and data. For example, the transceiver 601 may include a radio frequency (RF) transmitter for up-converting and amplifying the frequency of a transmitted signal and an RF receiver for low-noise-amplifying a received signal and down-converting the frequency thereof. The transceiver 601 may output a signal received through a wireless channel to the processor 602 and may transmit, through a wireless channel, a signal output from the processor 602.

According to another embodiment, the UE 402 may include a plurality of transceivers. For example, in the case of supporting evolved-universal terrestrial radio access-new radio (E-UTRA-NR) dual connectivity (EN-DC), the UE 402 may include a first transceiver supporting the 4G LTE wireless communication and a second transceiver supporting the 5G NR wireless communication. According to another embodiment, in the case of supporting NR-dual connectivity (NR-DC), the UE 402 may include a plurality of transceivers supporting the 5G NR wireless communication. According to still another embodiment, in the case of supporting near field wireless communication, the UE 402 may separately include a transceiver supporting at least one standard in the group of wireless communication protocol standards as defined in the protocol standards for Bluetooth, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

The processor 602 may control general operations of the UE 402 according to embodiments of the disclosure. The processor 602 may be implemented by one or more integrated circuit (or circuitry) (IC) chips and may execute various data processing operations. The processor 602 may include at least one electric circuit, and may execute instructions (or a program, codes, data, etc.) stored in the memory 603, individually, collectively or in any combination thereof. The processor 602 may include a single-core processor or multi-core processor, and may include a processor assembly including a plurality of processing circuits (circuitry) according to a specific implementation scheme.

The processor 602 may be electrically, operatively, and/or communicatively coupled to the transceiver 601 to control the transceiver 601.

The processor 602 may include at least one processor (or processing circuitry), and the at least one processor may perform the following operations individually, collectively or in any combination thereof. For example, the processor 602 may include a communication processor (CP) configured to control communication operations and an application processor (AP) configured to control execution of an upper layer (for example, an application layer). In a specific embodiment, at least a part of the processor 602 may be included in one chip and the other part of the processor 602 may be included in another chip. Otherwise, at least one processor may be included in another component, for example, the transceiver 601 or the memory 603.

In an embodiment, the processor 602 may perform or control or cause an operation of the UE 402 for executing at least one or a combination of methods according to embodiments of the disclosure. For example, the processor 602 may control operations of the UE 402 for processing a downlink signal received from a BS or generating and transmitting an uplink signal to a BS. To this end, the processor 602 may execute a computer program, codes, or instructions stored in the memory 603, so as to control other components of the UE 402 to enable execution of various operations.

In an embodiment, the memory 603 corresponds to a hardware storage device capable of temporarily or permanently storing information and may include one or more storage media. For example, the memory 603 may include memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 603 may be electrically, operatively, and/or communicatively coupled to the processor 602 and may be accessed by the processor 602.

The memory 603 may store a computer program, codes, or instructions executable by the processor 602. According to an embodiment, a computer program, codes, or instructions executable by the processor 602 may be either stored in a single memory device or separated and stored in a distributed manner in two or more memory devices. By executing the instructions stored in the memory 603, the processor 602 may perform various functions according to an embodiment of the disclosure.

According to an embodiment, operations of the UE 402 may be caused to be performed based on execution of instructions (or a computer program or codes) stored in the memory 603 by at least one processor (or processing circuitry) configured to execute the same individually, collectively, or in any combination thereof, based on processing circuitry that is not configured to execute instructions, and/or based on components of processing circuitry that is not configured to execute instructions.

Consider that the UE 402 is configured with a Tracking Area Identifier (TAI) list, wherein the TAI list comprises only S&F cells. Further, consider that the UE 402 has moved from the Store & Forward cell (S&F) cell to the non-S&F cell or vice versa. On determining that the UE 402 has moved from the S&F cell to the non-S&F cell or vice versa, the processor 602 can trigger the Tracking Area Update (TAU) procedure.

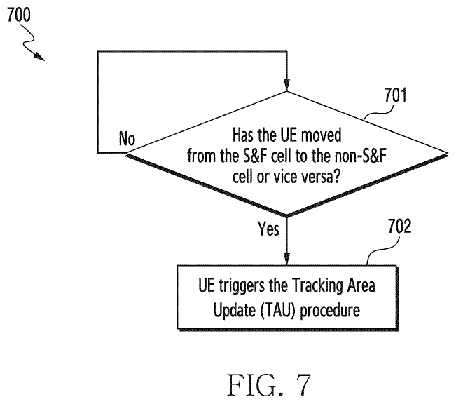

FIG. 7 is a flowchart depicting the process of managing the transition of the UE from a S&F cell to the non-S&F cell or vice versa according to an embodiment of the disclosure.

Consider that the UE 402 is configured with a Tracking Area Identifier (TAI) list, wherein the TAI list comprises only S&F cells. In operation 701, the UE 402 moves from the Store & Forward cell (S&F) cell to the non-S&F cell or vice versa. On determining that the UE 402 has moved from the S&F cell to the non-S&F cell or vice versa, in operation 702, the UE 402 triggers the Tracking Area Update (TAU) procedure. The various actions in method 700 may be performed in the order presented, in a different order or simultaneously. Further, in some embodiments, some actions listed in FIG. 7 may be omitted.

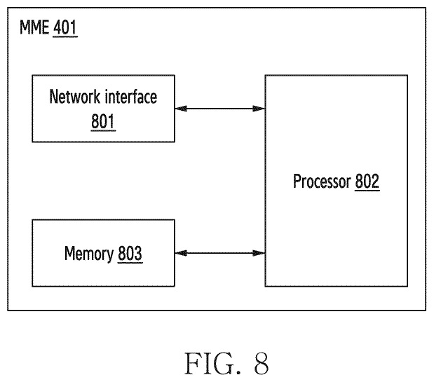

FIG. 8 depicts the MME. The MME 401 may include an entity (apparatus, device, or server, etc.) that performs one or more network functions (NFs) or a part of a network function constituting a core network (e.g., a 5th generation (5G) core (5GC)) in a communication system according to an embodiment of the disclosure.

In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the MME 401.

A single NF may be implemented by one or more instances, which may be deployed on the same network entity or distributed across multiple network entities to operate. The instance may be a software unit that logically executes a specific network function, and may be implemented in a form that is decoupled from physical hardware resources. Further, one or more NFs may be implemented in the form of one network slice to operate to satisfy specifications required by a particular service.

In an embodiment, the NF may include at least one of an access and mobility management function (AMF), a session management function (SMF), a local session management function (L-SMF), a user plane function (UPF), a local user plane function (L-UPF), a policy control function (PCF), a unified data management (UDM), a unified data repository (UDR), a network exposure function (NEF), a network repository function (NRF), an application function (AF), a network slice selection function (NSSF), a network data analytics function (NWDAF), a network slice admission control function (NSACF), an authentication server function (AUSF), a data network (DN), etc.

Referring to FIG. 8, the MME 401 may include at least one network interface 801, at least one processor 802 (hereinafter, “processor”), and at least one memory 803 (hereinafter, “memory”). As described above, a NF may be implemented in the form of a physical device (such as the MME 401), or may be virtualized and executed in the form of an instance. When implemented as an instance, the NF need not necessarily include physical components as illustrated in FIG. 8. In such a case, the instance may be logically represented as comprising one or more logical functional elements.

According to at least one or a combination of methods corresponding to the embodiments described in the disclosure, the network interface 801, the processor 802, and the memory 803 of the MME 401 may operate. However, components of the MME 401 are not limited to the example components illustrated in FIG. 8. In another embodiment, the MME 401 may further include additional components in addition to the above-mentioned components, or some components may be omitted. Further, in an embodiment, the network interface 801, the processor 802, or the memory 803 may be integrated in the form of one component.

In an embodiment, the network interface 801 is a collective term for a transmitter part of the MME 401 and a receiver part of the MME 401, and may be a communication circuit for transmitting or receiving a signal to or from a terminal, a base station (BS), or another network entity. Here, the communication circuit may include both a communication circuit for wireless communication and a communication circuit for a wired communication. For example, the network interface 801 may include a circuit, logic, hardware, etc., configured to exchange a control plane message or a user plane message with a terminal, a BS, or other core network entities through wireless communication or wired communication. The network interface 801 may operate using various protocols (e.g., non-access stratum (NAS) protocol). The network interface 801 may also be referred to, for convenience of description or depending on implementation, as communication circuitry, network interface circuitry, or a communication interface circuitry.

In another embodiment, the processor 802 may control general operations of the MME 401 according to embodiments of the disclosure. The processor 802 may be implemented by one or more integrated circuit (or circuitry) (IC) chips and may execute various data processing. The processor 802 may include at least one electric circuit, and may execute instructions (or a program, codes, data, etc.) stored in the memory 803, individually, collectively or in any combination thereof. Further, the processor 802 may include a single-core processor or multi-core processor, and may include a processor assembly including a plurality of processing circuits (circuitry) according to a specific implementation scheme. Further, it should be noted that, according to another embodiment, in a case where NF is implemented in the form of an instance, the network function may be not necessarily configured by physical hardware.

According to an embodiment, the processor 802 may be electrically, operatively, and/or communicatively coupled to the network interface 801 to control the network interface 801.

The processor 802 may include at least one processor (or processing circuitry), and the at least one processor may perform the following operations individually, collectively or in any combination thereof. In a specific embodiment, at least a part of the processor 802 may be included in one chip and the other part of the processor 802 may be included in another chip. Otherwise, at least one processor may be included in another component, for example, the network interface 801 or the memory 803.

The processor 802 may perform or control or cause, for example, an operation of the MME 401 for executing at least one or a combination of methods according to embodiments of the disclosure. For example, the processor 802 may control operations of the MME 401 for exchanging a control plane message or a user plane message with a terminal, a BS, or other core network entities through wireless or wired communication, using various protocols (e.g., NAS protocol). To this end, the processor 802 may execute a computer program, codes, or instructions stored in the memory 803, so as to control other components of the MME 401 to enable execution of various operations.

The memory 803 corresponds to a hardware storage device capable of temporarily or permanently storing information and may include one or more storage media. For example, the memory 803 may include memory assembly including one or more storage media. For example, the one or more storage media may include permanent memory, such as a hard drive, flash memory, or read-only memory (ROM), semipermanent memory, such as random access memory (RAM), cache memory, or a combination thereof.

In an embodiment, the memory 803 may be electrically, operatively, and/or communicatively coupled to the processor 802 and may be accessed by the processor 802.

The memory 803 may store a computer program, codes, or instructions executable by the processor 802. According to an embodiment, a computer program, codes, or instructions executable by the processor 802 may be either stored in a single memory device or separated and stored in a distributed manner in two or more memory devices. By executing the instructions stored in the memory 803, the processor 802 may perform various functions according to an embodiment of the disclosure.

According to an embodiment, operations of the MME 401 may be caused to be performed based on execution of instructions (or a computer program or codes) stored in the memory 803 by at least one processor (or processing circuitry) configured to execute the same individually, collectively, or in any combination thereof, based on processing circuitry that is not configured to execute instructions, and/or based on components of processing circuitry that is not configured to execute instructions.

The processor 802 can determine that the UE 402 has triggered a TAU procedure. The UE 402 triggering the TAU procedure can indicate to the processor 802 that the UE 402 has moved from the S&F cell to the non-S&F cell or vice versa. The processor 802 can notify the AF 301 that the UE has moved from the S&F cell to the non-S&F cell or vice versa, via the network interface 801. The processor 802 can further report an estimated S&F Downlink (DL) Delivery Time, and a Feeder Link (FL) availability period to the AF 301. The S&F DL Delivery Time can be the expected delay duration to deliver the data to the UE 402, wherein the processor 802 can estimate the S&F Downlink (DL) Delivery Time. The FL availability period can be the duration for which the FL is available.

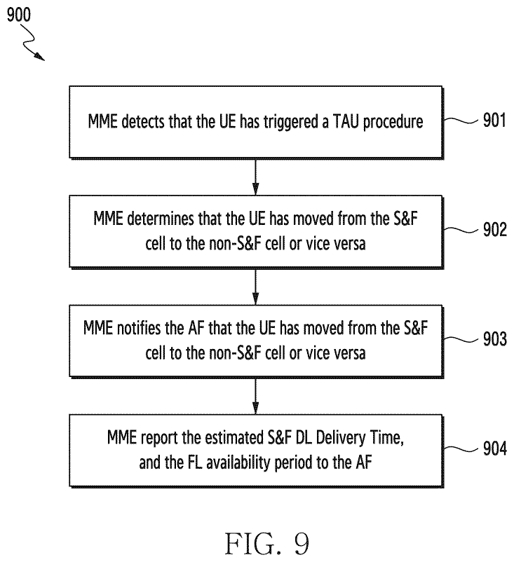

FIG. 9 is a flowchart depicting the process of the MME managing the transition of the UE from a S&F cell to the non-S&F cell or vice versa according to an embodiment of the disclosure.

In operation 901, the MME 401 detects that the UE 402 has triggered a TAU procedure. Accordingly, in operation 902, the MME 401 determines that the UE 402 has moved from the S&F cell to the non-S&F cell or vice versa. In operation 903, the MME 401 notifies the AF 301 that the UE has moved from the S&F cell to the non-S&F cell or vice versa. In operation 904, the MME 401 further reports the estimated S&F Downlink (DL) Delivery Time, and the Feeder Link (FL) availability period to the AF 301, wherein the S&F DL Delivery Time is the expected delay duration to deliver the data to the UE 402, and the FL availability period is the duration for which the FL is available. The various actions in method 900 may be performed in the order presented, in a different order or simultaneously. Further, in some embodiments, some actions listed in FIG. 9 may be omitted according to an embodiment of the disclosure.

The network as referred to herein can be at least one of the eNB, gNB or MME or AMF or UDM or HSS or any other core network element or network function.

Embodiments herein disclose a mechanism on how to handle the transitioning of the UE from the S&F cell to the non S&F cell, as if this transition is not managed well, the UE will start missing on to the mobile terminated data because the AF is not aware that the UE is available for data reception.

The embodiments disclosed herein can be implemented through at least one software program running on at least one hardware device and performing network management functions to control the network elements. The elements include blocks which can be at least one of a hardware device, or a combination of hardware device and software module.

In an embodiment, a method performed by a mobility management entity (MME) may comprise detecting that a monitoring event that a user equipment (UE) is moving from being registered in a store and forward (S&F) mode to not being registered in the S&F mode. The method may comprise, in response to detecting the monitoring event, transmitting, to a service capability server/application server (SCS/AS), a message indicating that the UE is moving from being registered in the S&F mode to not being registered in the S&F mode.

In an embodiment, the message may indicate an expected time required to deliver data to the UE.

In an embodiment, the message may indicate a feeder link availability period.

In an embodiment, the S&F mode may provide to the UE a communication service when a serving satellite for the UE has a discontinuous connection to a ground network.

In an embodiment, the method may comprise allocating, to the UE, a tracking area identity (TAI) list such that a S&F cell and a non S&F cell are not included in the same TAI list.

In an embodiment, the MME may include communication circuitry. The MME may include memory, including one or more storage media. The MME may include at least one processor including processing circuitry. The instructions, when executed by the at least one processor individually or collectively, may cause the MME to detect that a monitoring event that a user equipment (UE) is moving from being registered in a store and forward (S&F) mode to not being registered in the S&F mode. The instructions, when executed by the at least one processor individually or collectively, may cause the MME to, in response to detecting the monitoring event, transmit, to a service capability server/application server (SCS/AS), a message indicating that the UE is moving from being registered in the S&F mode to not being registered in the S&F mode.

In an embodiment, the message may indicate an expected time required to deliver data to the UE.

In an embodiment, the message may indicate a feeder link availability period.

In an embodiment, the S&F mode may provide to the UE a communication service when a serving satellite for the UE has a discontinuous connection to a ground network.

In an embodiment, the instructions, when executed by the at least one processor individually or collectively, may cause the MME to allocate, to the UE, a tracking area identity (TAI) list such that a S&F cell and a non S&F cell are not included in the same TAI list.

Meanwhile, although specific embodiments of the disclosure have been described in detail, various modifications may be made without departing from the scope of the disclosure. Therefore, the scope of the disclosure should not be limited to the described embodiments, but should be defined by the claims and equivalents thereof.

The embodiments disclosed herein describe methods and systems for managing transition of a User Equipment (UE) from a Store & Forward (S&F) cell to a non S&F cell, which involves detecting by a Mobility Management Entity (MME) that the UE has moved from the S&F cell to the non S&F cell, and indicating to the AF the UE is moving from a S&F mode to a not registered in S&F cell, wherein the AF schedules the data to the UE based on information received from the MME. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a mobility management entity (MME), the method comprising:
detecting that a monitoring event that a user equipment (UE) is moving from being registered in a store and forward (S&F) mode to not being registered in the S&F mode; and
in response to detecting the monitoring event, transmitting, to a service capability server/application server (SCS/AS), a message indicating that the UE is moving from being registered in the S&F mode to not being registered in the S&F mode.

2. The method of claim 1,
wherein the message further indicates an expected time required to deliver data to the UE.

3. The method of claim 1,
wherein the message further indicates a feeder link availability period.

4. The method of claim 1,
wherein the S&F mode provides to the UE a communication service when a serving satellite for the UE has a discontinuous connection to a ground network.

5. The method of claim 1, further comprising:
allocating, to the UE, a tracking area identity (TAI) list such that a S&F cell and a non S&F cell are not included in the same TAI list.

6. A mobility management entity (MME) comprising:
communication circuitry;
memory, including one or more storage media; and
at least one processor including processing circuitry, wherein the instructions, when executed by the at least one processor individually or collectively, cause the MME to:
detect that a monitoring event that a user equipment (UE) is moving from being registered in a store and forward (S&F) mode to not being registered in the S&F mode; and
in response to detecting the monitoring event, transmit, to a service capability server/application server (SCS/AS), a message indicating that the UE is moving from being registered in the S&F mode to not being registered in the S&F mode.

7. The MME of claim 6,
wherein the message further indicates an expected time required to deliver data to the UE.

8. The MME of claim 6,
wherein the message further indicates a feeder link availability period.

9. The MME of claim 6,
wherein the S&F mode provides to the UE a communication service when a serving satellite for the UE has a discontinuous connection to a ground network.

10. The MME of claim 6,
wherein the instructions, when executed by the at least one processor individually or collectively, cause the MME to:
allocate, to the UE, a tracking area identity (TAI) list such that a S&F cell and a non S&F cell are not included in the same TAI list.
